(19) United States
(12) Patent Application Publication
(10) Pub. No.: US 2019/0303985 A1
(43) Pub. Date: Oct. 3, 2019

(54) Automated Generation Of Listings For Online Marketplaces

(71) Applicant: SELLHOUND INC., Santa Cruz, CA (US)

(72) Inventor: Suzanne Small Wouk, Santa Cruz, CA (US)

(73) Assignee: SELLHOUND INC., Santa Cruz, CA (US)

(21) Appl. No.: 16/374,659

(22) Filed: Apr. 3, 2019

Related U.S. Application Data
(60) Provisional application No. 62/652,301, filed on Apr. 3, 2018.

(51) Int. Cl. G06Q 30/06; G06T 7/70

(52) U.S. Cl. CPC G06Q 30/0603; G06T 7/70

(57) ABSTRACT

The subject invention automatically generates a listing for an item to be sold on a marketplace, by maintaining a library of motifs, where a motif corresponds to a category of products and specifies attributes, and rules for automatically generating a generic listing, receiving at least one photo of an item to be sold, automatically determining a category of products to which the item belongs, based solely on the photos, selecting a motif that corresponds to the determined category, obtaining values for attributes specified by the selected motif, and automatically creating a generic listing.

### BACKGROUND

Online marketplaces have proliferated and present a challenge for sellers. In addition to popular marketplaces such as EBAY and CRAIGSLIST, there are many other marketplaces for used, or secondhand, goods. When selling an item on an online marketplace the seller must create a listing, i.e. provide descriptive information for a listing form provided by the marketplace. However, sellers often do not have product literature, sales receipts, sales tags or other documentation that can be used to provide the proper descriptive information required to create a complete listing.

Therefore, it would be advantageous to provide assistance to an individual that wishes to sell items on online marketplaces. Such assistance might include generating descriptive information for a listing based on photos provided by a seller, selecting optimized keywords for important fields such as title and description, automatically generating a title, descriptive information, a price, shipping information and other information required in a listing form and identifying relevant marketplaces.

In addition, each online marketplace has unique terms and conditions that a listing must conform to. For example, EBAY restricts the length of a title to no more than 80 characters, while POSHMARK restricts the title to 50 characters and MERCARI restricts the title to 40 characters. As another example, different marketplaces offer different shipping services and shipping prices. Therefore, it would be advantageous to provide a tool that would facilitate listing an item on multiple marketplaces by automatically generating listings that conform to the terms and conditions of each marketplace.

Thus, it is with respect to these considerations and others that the present invention has been made.

### SUMMARY OF THE DESCRIPTION

Various embodiments are directed towards a method and system for generating a listing for one or more marketplaces for an item provided by a seller for sale. The seller provides one or more digital photos of the item and the invention automatically generates listings for one or more marketplaces.

The subject invention discloses a method that employs results from an image recognition subsystem to automatically classify an item into a product category based solely on photos provided by a seller. A motif, which corresponds to the product category, is selected that specifies attributes to be obtained for the item and a set of rules on how to generate parts of a listing, including a title, a description, a price, and shipping method. Customized listings may be generated for various marketplaces that conform to listing rules specific to each marketplace.

In certain embodiments, a server computer implements key steps in the method for automatically generating a listing. The computer server includes a library of motifs where a motif corresponds to a product category and uniquely specifies both the attributes that define the product category and the rules to apply to the attributes to automatically generate a listing for a marketplace.

The subject invention further includes a method for processing the results from an image recognition library to obtain values for the attributes specified in a motif from one or more photos.

The subject invention is directed to a method for automatically generates a listing for an item to be sold on a marketplace, by maintaining a library of motifs, where a motif corresponds to a category of products and specifies attributes, and rules for automatically generating a generic listing, receiving at least one photo of an item to be sold, automatically determining a category of products to which the item belongs, based solely on the photos, selecting a motif that corresponds to the determined category, obtaining values for attributes specified by the selected motif, and automatically creating a generic listing.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a block diagram of an embodiment of an automated system for automatically generating listings for one or more marketplaces based solely on photos provided by a seller.

FIG. 2 illustrates an embodiment of a flow diagram of a method that automatically generates a listing for an item to be sold on one or more marketplaces.

FIG. 3 is a flow diagram of an exemplary method that uses image recognition to obtain values for attributes specified by a motif.

FIG. 4 provides an example of the attributes and acceptable values for the attributes specified in a motif for a product category.

FIG. 5 is an example of a user interface that enables a reviewer to supply attributes for a women's blouse.

FIG. 6 is an example of the results obtained from several reviewers of a product.

FIG. 7 is an example of a set of rules included in a motif that are used to generate a title for a listing.

FIG. 8 illustrates an example of a listing that is automatically generated and provided to a seller for review prior to posting it on a marketplace.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Item, product, or SKU—refers to a tangible item or product such as an item of clothing or a car, or it may refer an item of service such as a carwash or medical service, that can be sold on a marketplace.

Seller—refers to an individual or entity that wishes to sell an item.

Online marketplace or marketplace—refers to a website or collection of websites that sell items on behalf of sellers. A seller “lists” an item with an online marketplace.

Listing—refers to the information that must be provided by a seller to include an item in the online marketplace for sale. The terms and conditions that a listing must conform to may vary for each marketplace. However, a listing typically includes an alphanumeric title, a description, images, price, and shipping information.

The subject invention works in conjunction with any online marketplace. Further the subject invention may be used to generate a listing for any product, service or other item. While the embodiments described herein are confined to items that are being posted to a marketplace for sale the intervention is not so constrained. For example, the invention may be used to generate information for inter alia insurance purposes, forms generation, information about a business or property. While embodiments require that a digital image of an item be provided the invention is not so limited and there are embodiments in which no digital image is required.

### Generalized Operation

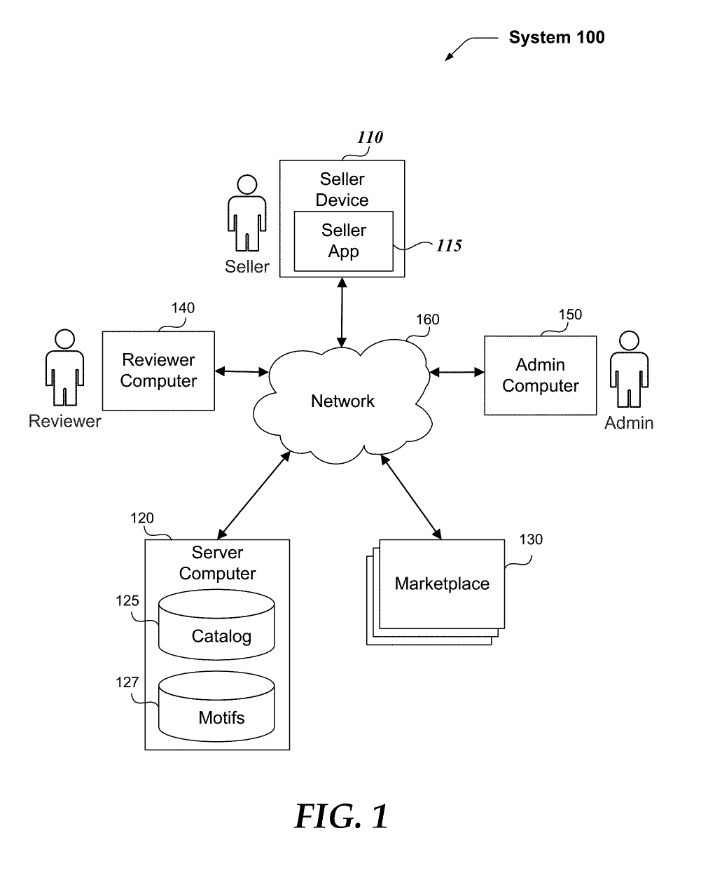

The operation of certain aspects of the invention is described below with respect to FIGS. 1-8.

FIG. 1 is a block diagram of an embodiment of an automated system 100 for automatically generating listings for one or more marketplaces 130 based solely on photos provided by a seller. The seller using a seller device 110 provides information to a server computer 120 about an item for sale.

Seller device 110 may be a mobile phone or other mobile device, a personal computer or other device capable of interacting with a user and interacting with a server computer 120 across a network 160. Seller device 110 includes a seller app 115 that interacts with a seller to guide the seller to take one or more photos of an item he/she wishes to sell on a marketplace and then uploads the photos, in digital format, to server computer 120 for review and further processing. Note that the terms photo, digital photo, image and digital image are used interchangeably herein and refer to a photograph in digital format.

Seller app 115 operates in conjunction with a server computer 120 which performs aspects of generating a listing, posting a listing and managing a listing.

Server computer 120 is a computer device that includes nontransitory memory and/or data storage including a database or catalog 125 of stock keeping units (SKUs) that have been previously identified and a library of motifs 127. Server computer 120 is equipped with a transceiver or other communications interface that enable it to transmit and receive information across network 160.

Server computer 120 receives listing information concerning an item for sale from seller device 110. In certain embodiments, this information is limited to one or more digital images of the item. In other embodiments, the seller supplies additional information about the item.

In certain embodiments, server computer 120 uses image recognition (IR) or artificial intelligence (AI), referred to collectively as IR, to automatically extract information regarding the item for sale. In certain embodiments, IR automatically processes the photos and generates a set of keywords. In other embodiments, IR processes the photos and deduces attributes of the item, examples of such attributes that may be automatically extracted include inter alia size, shape, product type or category, and texture.

Network 160 may be the public Internet, a mobile network, a local area network or any other electronic network. Network 160 may further be a combination of interconnected networks.

In certain embodiments, server computer 120 interacts with one or more reviewers, each using a reviewer computer 140, to obtain information about a listing. A reviewer may provide information in addition to or in place of information obtained automatically by IR. A reviewer may refer to inter alia one or more staff members, or to a crowdsource service. In certain embodiments, a goal is to obtain a plurality of results or opinions regarding selected attributes of being sold and to achieve consensus regarding the actual values of each of the selected attributes. Crowdsource services that may acts a reviewer include AMAZON MECHANICAL TURK and other 3^{rd} party services. In addition, a crowdsource service acting as a reviewer may include individuals not affiliated with a company or service who collectively act as a reviewer.

Server computer 120 includes a catalog of product. Each product in the catalog has a set of attributes that uniquely identify the product. Server computer 120 further includes library of motifs 127.

A motif specifies both the attributes necessary to uniquely define a category of product, a set of acceptable values for each attribute, and the rules to apply to the attributes to automatically generate a listing for a marketplace. For example, fashion motifs may include women's tops, women's pants, women's sweaters, men's dress shirts, men's hats, men's pants, etc. Attributes may include brand, size, material, etc. Rules to apply may be used to generate a title, description, price, shipping service, etc.

Motifs are defined and managed by administrative (admin) staff using an administrative computer 150. Admin staff may also perform routine tasks such as database maintenance that are outside the scope of the subject invention.

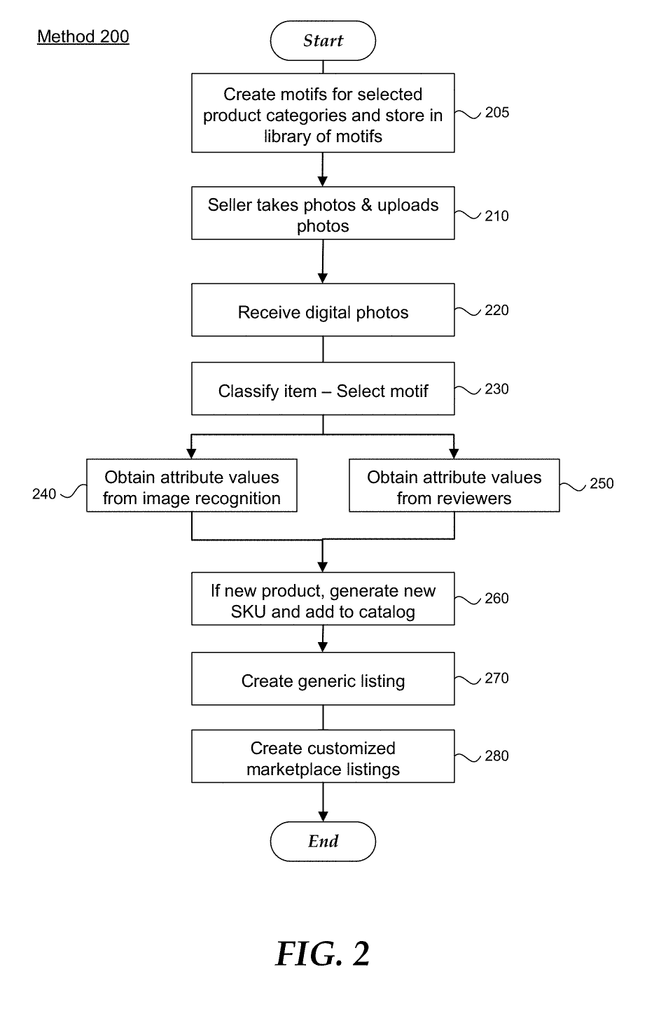

FIG. 2 illustrates an embodiment of a flow diagram of a method 200 that automatically generates a listing for an item to be sold on one or more marketplaces.

At step 205 admin staff, using admin computer 150, create motifs for selected product categories. This step is performed prior to and asynchronously from the other steps in method 200. The ability to automatically generate a product listing requires that a motif be present in library of motifs 127 for a product category that corresponds to the item to be sold. Thus, the effectiveness of system 100 relies on creating and maintaining motifs for a large number of product categories. A motif provides a way to structure data concerning individual products and rules for defining SKUs and marketplace listings for the SKUs. Thus, the creation and maintenance of motifs 127 is central to the value provided by system 100.

At step 210 a seller takes one or more photos of an item that he/she wishes to list on one or more marketplaces. To accomplish this, seller 200 typically interacts with seller app 115 running on seller device 110, which guides the seller to take specific photos. Such specific photos may include a frontal view, a side view, a bottom view and a view of a label, tag or barcode. In certain embodiments, seller app 115 may enable the seller to provide additional information about the listing. However, for purposes of the present invention it is assumed that the seller does not provide supplemental information and the only seller input to method 200 are one or more photos. Seller device 110 uploads the photos to server computer 120 across network 160.

At step 220 server computer 120 receives the photos, in the form of digital images, and any supplemental information provided by the seller.

At step 230 server computer 120 classifies the item, i.e. it performs a classification process in order to determine the type or category of product that is being sold and selects a corresponding motif from library of motifs 127. The motif, in turn, specifies the attributes required to fully specify the product to be listed. Generally, an image recognition sub-system (IR) is used to classify the product category from the photos. In some case, a human reviewer may need to correct or supply a product type, but recent advances in IR make it possible to automatically classify a product from one or more photos. Two commercially available subsystems that perform classification based on photos are GOOGLE CLOUD VISION, from GOOGLE LLC of Mountain View, Calif. and CLOUDSIGHT from CLOUDSIGHT INC.

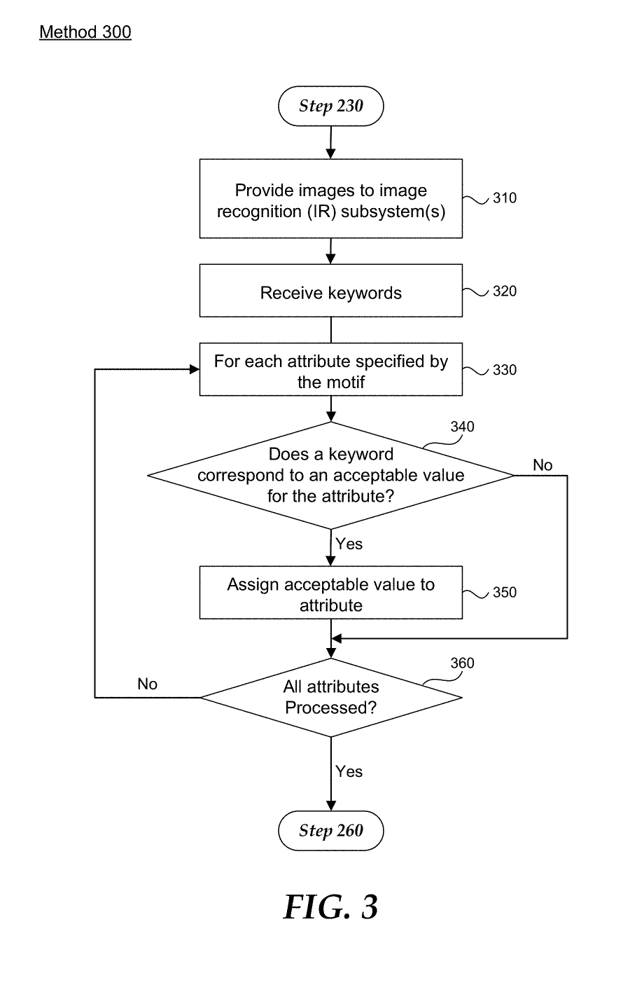

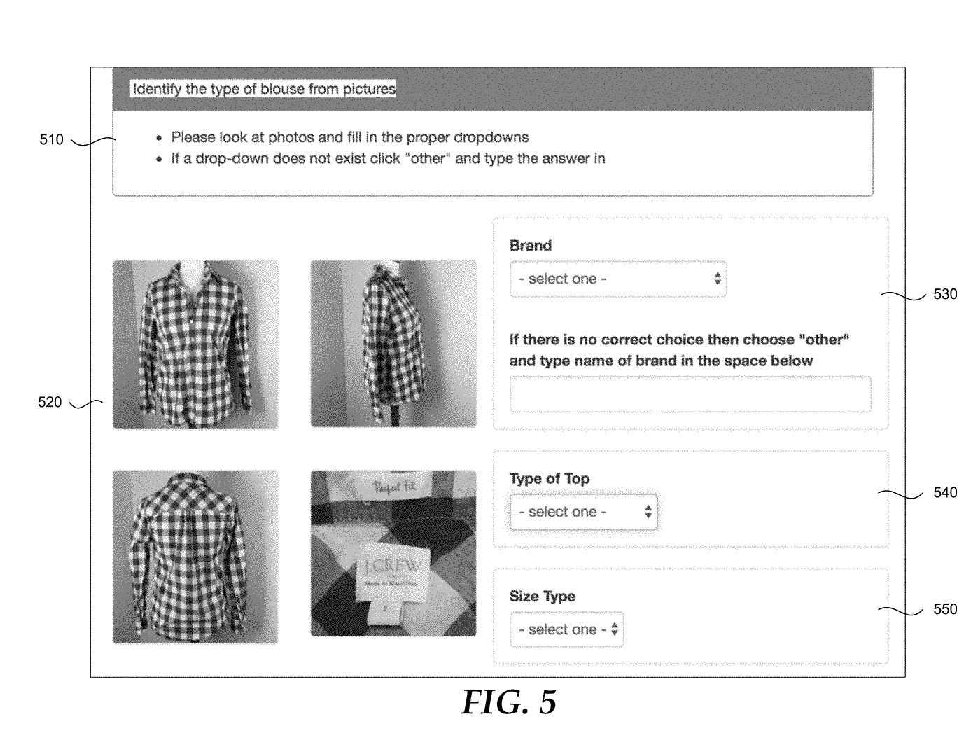

At step 240 and 250 the various attributes that correspond to the motif for the item are obtained. In certain embodiments, image recognition (IR) is used to automatically obtain attributes. A method for obtaining attributes using IR is described if further detail with reference to FIG. 3, below. In other embodiments, human reviewers are asked to provide attributes. An example of a reviewer interface that may be used by a reviewer to provide attributes is described with reference to FIG. 5, below.

At step 260 if the values for the determined product type are unique, i.e. not already present in catalog 125, a new SKU is generated and added to catalog 125. A SKU typically includes (1) a unique identifier, (2) a product name, and (3) values that correspond to each of the attributes defined by the corresponding motif. a li

At step 270 the attributes and product type are used to create a generic listing. Then at step 280 one or more marketplace listings are generated where a marketplace listing is generated from the generic listing by applying any listing rules specific to the marketplace. The marketplace listings created at this step may be determined by the seller or may reflect a set of marketplaces suggested to the seller.

Listings automatically created by server computer 120 may be presented to the seller for review and posting to one or more marketplaces. In certain embodiments, upon receiving approval by the seller a listing is automatically uploaded and posted to one or more marketplaces by server computer 120.

FIG. 3 is a flow diagram of an exemplary method 300 that uses image recognition (IR) to obtain values for attributes specified by a motif. Method 300 performs step 240 of method 200.

At step 310 the images received at step 220 of method 200 are provided to an IR subsystem. As discussed earlier, a number of commercially available subsystems can be used for this purpose. For purposes of method 300 all that is required is that an IR subsystem analyze the digital images and return, at step 320, a set of applicable key words. More than one IR subsystem may be employed at this step. While some IR subsystems may provide confidence values or weights for the keywords they discover this functionality is not required by method 300.

At step 330 a loop is initiated that sequentially processes each of the attributes specified by the motif selected at step 230. At step 340, a determination is made for the attribute being processed as to whether one of the received keywords is an acceptable value for the attribute. If not, then processing flows to step 360. If so, then at step 350 the keyword is assigned to the corresponding attribute in the motif.

At step 360 a determination is made as to whether all the received attributes have been processed. If so then the method terminates. If not then processing returns to step 330 and the next attribute is processed.

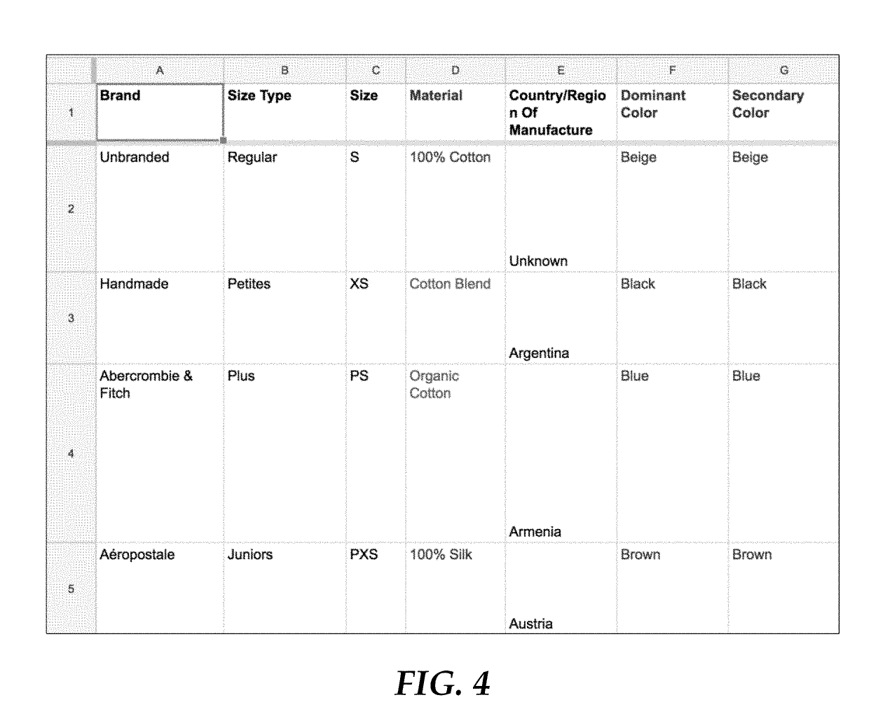

FIG. 4 provides an example of the attributes and acceptable values for the attributes specified in a motif for a product category. In this example, the motif corresponds to the product category “women's tops”. Each column in the table refers to an attribute of a woman's top that is used both to define a SKU for the product and to generate a listing. For example, the attributes shown in FIG. 4 are brand, size type, size, material, country/region of manufacture, dominant color, secondary color. Motifs for different product categories typically include different attributes.

The row values for each column list the acceptable values for an attribute. For example, under the attribute named “Size Type” the acceptable values are Regular, Petites, Plus, Juniors. In certain embodiments, synonyms, stems, and other words that are equivalent to an acceptable word are themselves acceptable.

FIG. 5 is an example of a user interface that enables a reviewer to supply attributes for a women's blouse. At instructions panel 510 provides instructions to the reviewer. A photo panel 520 shows four photos the product that were supplied by the seller. A brand panel 530 enables the reviewer to specify the brand. A type panel 540 enables the reviewer to specify the type of top. A size panel 550 enables the reviewer to specify the size of the top. When the evaluator completes reviewing the product and provides all requested information=he/she selects a “finished” control and the review is transmitted to server computer 120 for further processing.

In certain embodiments, more than one reviewer is asked to supply input for a product. For example, if the reviewer function is provided by a crowdsource service then system 100 will ask the crowdsource service to provide multiple reviews and will then attempt to obtain a consensus as to the correct value for each attribute.

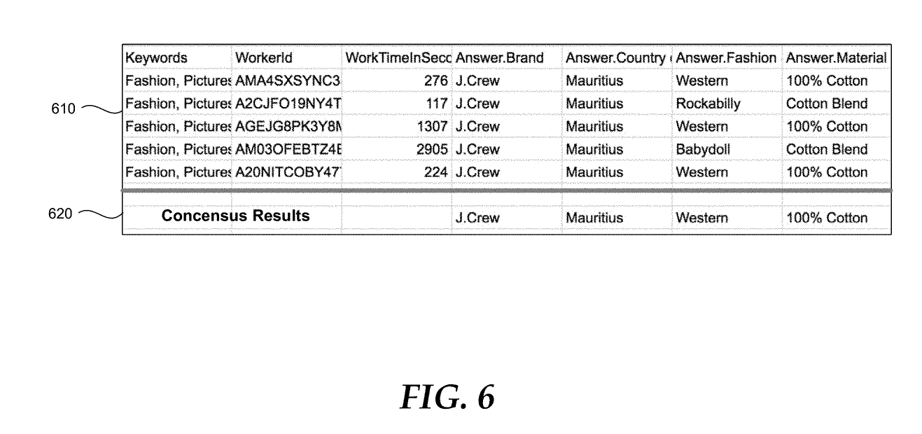

FIG. 6 is an example of the results obtained from several reviewers of a product. A data panel 610 shows the answers provided by each of the five evaluators, each of which has a unique worker id, relative to the attributes brand, country of origin, fashion type, and material. A consensus results panel 620 shows the determined consensus for each attribute: brand (I Crew), country of origin (Mauritius), fashion (Western), and material (100% Cotton). It may be appreciated that consensus relative to an attribute may be defined in various ways. For example, in one embodiment if a majority select the same attribute then that attribute may be determined to be the consensus selection. In another embodiment, the opinion of one reviewer may be used to break a tie.

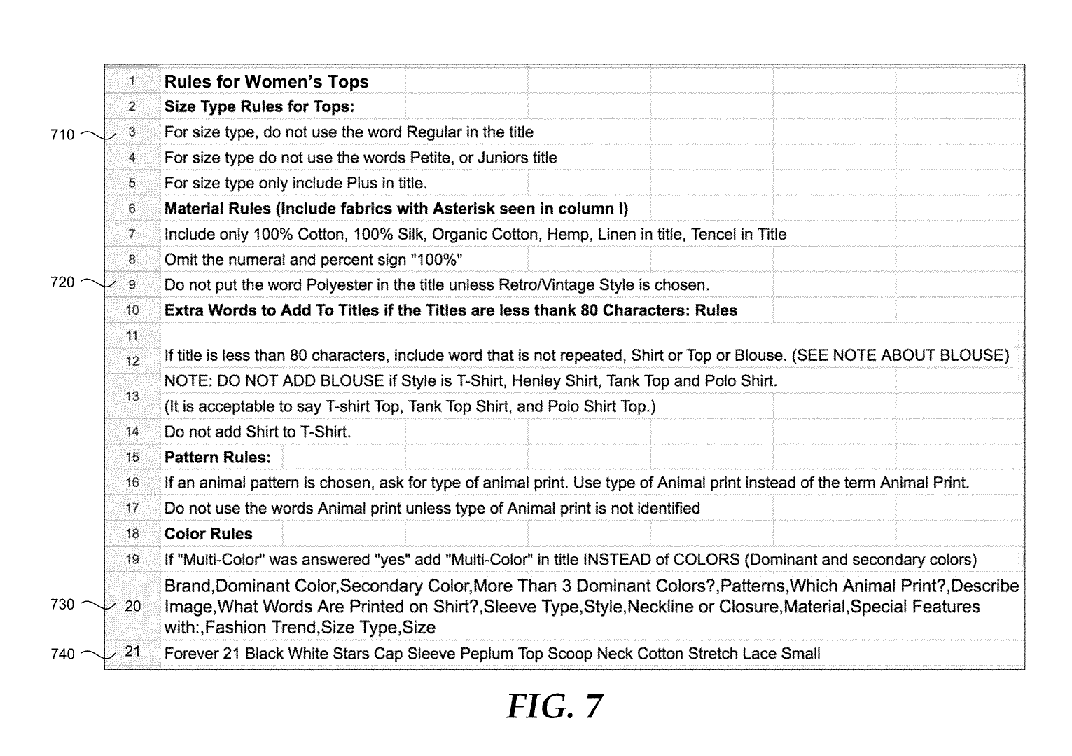

FIG. 7 is an example of a set of rules included in a motif that are used to generate a title for a listing. The rules for the motif for the product category “women's tops” cover size, material, extra words to add, pattern and color. For example, rule 710, in column 3, specifies that the word Regular should not be used in the title. Rule 720, in column 9, specifies that the word “Polyester” should not be included unless Retro/Vintage Style is chosen.

A title generation rule 730 is used to combine the attributes for a product into a generic title. For the example product, not depicted, the title generated by generation rule 730, given as title 740 is:
Forever 21 Black White Stars Cap Sleeve Peplum Top Scoop Neck Cotton Stretch Lace Small

In addition to a title generation rule, a motif typically includes generation rules for the description field of a listing, and the price and shipping selection.

The rules for automatically generating a description are also specified in a motif. In many cases the rules for a description are specific to each marketplace. For example, one marketplace recommends that the description be the same as a title. Another marketplace allows for more text in a description field than in a title field, thus additional keywords can be added. A description may include specific phrases such as “Thanks for looking”, “Sold as pictured”, or adjectives such as “beautiful”.

The invention also automatically generates a recommended price for an item. In one embodiment, server 120 searches a leading marketplace, such as EBAY, for items that are similar to the item being listed, using the values for selected attributes such as brand, style and material as the search terms. Results may be filtered according to new, used, sold, etc. Then an average or other statistical measure is used to determine a price.

The invention also automatically determines a shipping cost. In certain embodiments, shipping cost is based on an item's weight and size. Additional considerations in estimating shipping cost include the item's product type, material and size attributes. The cost is then synchronized or modified based on the type of shipping, e.g. courier or US Postal Service.

In addition to the rules specified by motifs for generating a generic listing, a library of marketplace-specific rules may be specified and maintained. These rules specify any marketplace specific requirements that fields such as title, description, price and shipping must conform to. For example, each marketplace typically restricts the title and description field to a maximum number of characters or words. Thus, marketplace-specific rules for the title and description fields will typically include field length limits. In order, to limit the length of title and description relative weights may be specified for each attribute that prioritize the attributes to include when generating the listing.

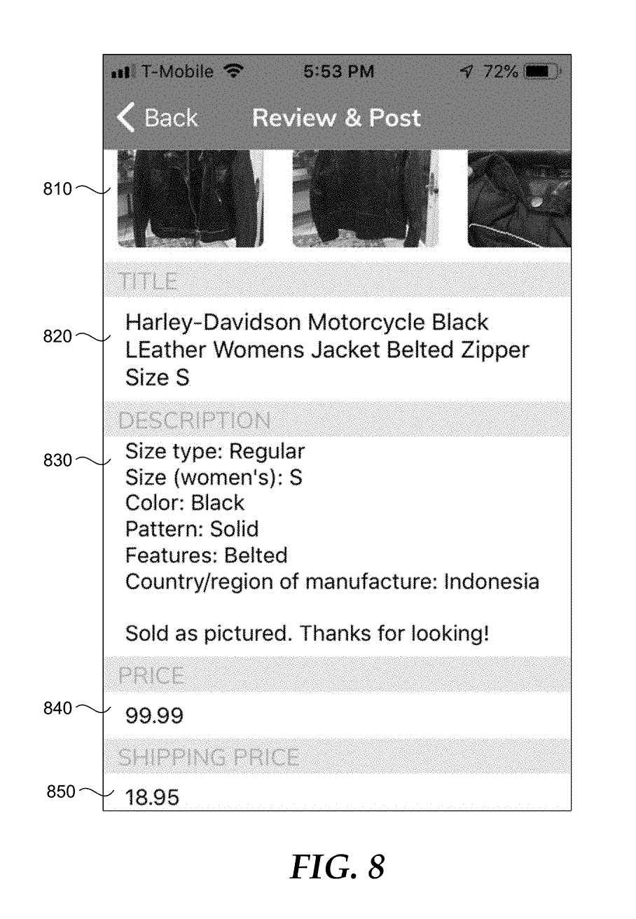

FIG. 8 illustrates an example of a listing that is automatically generated and provided to a seller for review prior to posting it on a marketplace. A photo panel 810 displays the digital images received from the seller. A title panel 820 displays an automatically generated title. A description panel 830 displays an automatically generated description of the item. The description lists the various attributes in the motif for the product category “women's jacket” along with the determine values for each attribute. The sentences “Sold as Pictured. Thanks for looking!” are included at the bottom of the description field. A price panel 840 provides an automatically determined recommended price for the item. A shipping price panel 850 provides an automatically determined recommended shipping price for the item.

### Additional Configuration Considerations

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for automatically generating a listing for an item to be sold, comprising:
maintaining a library of motifs, wherein a motif corresponds to a category of products and specifies (1) one or more attributes, each attribute characterizing products in the category wherein an attribute may be assigned a value that pertains to an item being sold, and (2) one or more rules for automatically generating a generic listing for an online marketplace from values assigned to the attributes in the motif;
receiving at least one photo of an item to be sold on a marketplace from a seller;
automatically determining a category of products to which the item belongs, based solely on the at least one received photo;
selecting a motif that corresponds to the determined category from the library of motifs;
obtaining at least one value for at least one attribute specified by the selected motif; and
automatically creating a generic listing for the item from the rules specified by the selected motif based in part on the obtained at least one value.

2. The method of claim 1 wherein automatically determining a category of products comprises:
providing the at least one photo to an image recognition subsystem; and
receiving from the image recognition subsystem a value for the category of products.

3. The method of claim 1 wherein a motif further specifies a set of acceptable values for each attribute, and wherein obtaining at least one value for at least one attribute specified by the selected motif comprises:
providing the at least one photo to an image recognition subsystem;
receiving from the image recognition subsystem at least one keyword;
for at least one attribute specified by the selected motif, determining that at least one of the at least one received keywords corresponds to an acceptable value for the at least one attribute; and
assigning the acceptable value to the at least one attribute.

4. The method of claim 1 wherein the one or more rules for automatically creating a generic listing comprises a rule for automatically generating a title and wherein automatically creating a generic listing comprises:
automatically generating a title using the rule for automatically generating a title.

5. The method of claim 1 wherein the one or more rules for automatically creating a generic listing comprises a rule for automatically generating a description and wherein automatically creating a generic listing comprises:
automatically generating a description using the rule for automatically generating a description.

6. The method of claim 1 wherein the one or more rules for automatically creating a generic listing comprises a rule for automatically generating a price and wherein automatically creating a generic listing comprises:
automatically generating a price using the rule for automatically generating a price.

7. The method of claim 1 wherein at least one of the at least one attribute is selected from the group consisting of a brand, a size type, a size, a material, a country or region of manufacture, a color, and a dominant color.

8. The method of claim 1 further comprising:
maintaining a library of marketplace-specific rules that specify specific constraints on listings for at least one marketplace; and
creating a listing for each of the at least one marketplace by applying the marketplace-specific rules to the generic listing.

9. The method of claim 8 wherein at least one of the marketplace-specific rules is selected from the group consisting of a limit on the length of the title and a limit on the length of the description.

10. The method of claim 1 further comprising:
maintaining a catalog of SKUs wherein a SKU represents a unique product;
determining that there is no SKU in the catalog which has the same attribute values as those obtained for the item;
generating a new SKU that corresponds to the item; and
adding the new SKU to the catalog.

11. A device for automatically generating a listing for an item to be sold, comprising:
a processor;
a communication interface in communication with the processor;
a data storage for storing a library of motifs, wherein a motif corresponds to a category of products and specifies (1) one or more attributes, each attribute characterizing products in the category wherein an attribute may be assigned a value that pertains to an item being sold, and (2) one or more rules for automatically generating a generic listing for an online marketplace from values assigned to the attributes in the motif;
a memory in communication with the processor for storing instructions, which when executed by the processor cause the device:
to maintain the library of motifs;
to receive at least one photo of an item to be sold on a marketplace from a seller;
to automatically determine a category of products to which the item belongs, based solely on the at least one received photo;
to select a motif that corresponds to the determined category from the library of motifs;
to obtain at least one value for at least one attribute specified by the selected motif; and
to automatically create a generic listing for the item from the rules specified by the selected motif based in part on the obtained at least one value.

12. The device of claim 11 wherein automatically determining a category of products comprises:
providing the at least one photo to an image recognition subsystem; and
receiving from the image recognition subsystem a value for the category of products.

13. The device of claim 11 wherein a motif further specifies a set of acceptable values for each attribute, and wherein obtaining at least one value for at least one attribute specified by the selected motif comprises:
providing the at least one photo to an image recognition subsystem;
receiving from the image recognition subsystem at least one keyword;
for at least one attribute specified by the selected motif, determining that at least one of the at least one received keywords corresponds to an acceptable value for the at least one attribute; and
assigning the acceptable value to the at least one attribute.

14. The device of claim 11 wherein the one or more rules for automatically creating a generic listing comprises a rule for automatically generating a title and wherein automatically creating a generic listing comprises:
automatically generating a title using the rule for automatically generating a title.

15. The device of claim 11 wherein the one or more rules for automatically creating a generic listing comprises a rule for automatically generating a description and wherein automatically creating a generic listing comprises:
automatically generating a description using the rule for automatically generating a description.

16. The device of claim 11 wherein the one or more rules for automatically creating a generic listing comprises a rule for automatically generating a price and wherein automatically creating a generic listing comprises:
automatically generating a price using the rule for automatically generating a price.

17. The device of claim 11 wherein at least one of the at least one attribute is selected from the group consisting of a brand, a size type, a size, a material, a country or region of manufacture, a color, and a dominant color.

18. The device of claim 11 wherein the instructions, when executed by the processor further cause the device:
to maintain a library of marketplace-specific rules that specify specific constraints on listings for at least one marketplace; and
to create a listing for each of the at least one marketplace by applying the marketplace-specific rules to the generic listing.

19. The device of claim 18 wherein at least one of the marketplace-specific rules is selected from the group consisting of a limit on the length of the title and a limit on the length of the description.

20. The device of claim 11 wherein the instructions, when executed by the processor further cause the device:
to maintain a catalog of SKUs wherein a SKU represents a unique product;
to determine that there is no SKU in the catalog which has the same attribute values as those obtained for the item;
generating a new SKU that corresponds to the item; and
adding the new SKU to the catalog.
